(19) United States
(12) Patent Application Publication
(10) Pub. No.: US 2016/0210380 A1
(43) Pub. Date: Jul. 21, 2016

(54) COMPUTER-IMPLEMENTED METHOD FOR AUTOMATIC GENERATION OF AT LEAST ONE BLOCK REPRESENTING A DRIVER FUNCTION FOR A BLOCK-BASED MODELING ENVIRONMENT

(71) Applicant: dSPACE digital signal processing and control engineering GmbH, Paderborn (DE)

(72) Inventors: Marius MUELLER, Paderborn (DE); Frank MERTENS, Bad Lippspringe (DE)

(73) Assignee: dSPACE digital signal processing and control engineering GmbH, Paderborn (DE)

(21) Appl. No.: 14/695,431

(22) Filed: Apr. 24, 2015

(30) Foreign Application Priority Data
Jan. 20, 2015 (DE) 10 2015 100 736.3

(51) Int. Cl. G06F 17/50

(52) U.S. Cl. CPC G06F 17/5009

(57) ABSTRACT

A computer-implemented method for automatic generation of at least one block representing a driver function for a block-based modeling environment, wherein the driver function serves to control a hardware element of a target hardware unit, the method including preparing a description of the driver function in a formal language, reading in and evaluating the formal-language description of the driver function, and generating the block representing the driver function for modeling of the driver function in a block diagram of the modeling environment.

This nonprovisional application claims priority under 35 U.S.C. §119(a) to German Patent Application No. 10 2015 100 736.3, which was filed in Germany on Jan. 20, 2015, and which is herein incorporated by reference.

### BACKGROUND OF THE INVENTION

1. Field of the Invention

The present invention relates to a computer-implemented method for automatic generation of at least one block representing a driver function for a block-based modeling environment, wherein the driver function serves to control a hardware element of a target hardware unit.

2. Description of the Background Art

Block-based modeling environments have been used primarily in industrial research and development to represent technical systems in the form of mathematical models, where the use of block diagrams for modeling transfer functions and signal flows has been considered to be an established working method for decades. Technical areas of application can be found anywhere that open-loop and closed-loop controls must be developed, tested, and implemented, for example in the automotive industry, in aerospace, and in other technological fields in which complex technical systems are to be developed.

An extensive application area for block-based modeling environments is the development of control units, for example, electronic control unites (ECUs). The block-based modeling environments then typically are not used to merely create a mathematical representation of reality, but instead the block-based modeling environment is used to automatically translate the functionality modeled with its aid—for example a closed loop controller—into an executable control program that can be executed on the target hardware, which is to say the control unit.

In this way, even complex functionalities can be translated from a block diagram into a control program for the target hardware in an automated, and consequently essentially error-free, manner. The target hardware, for example in the form of a development or production control unit, is then placed in the technical process to be influenced (motor vehicle, aircraft, industrial plant) and interacts through its I/O interfaces with this technical process in that it senses state variables of the technical process through measurement and influences the technical process through the output of output variables. Examples of development tools of this type known from the conventional art include “ConfigurationDesk” (“Configuration-Desk”, dSPACE Catalog 2012, pages 60 ff.) and “Real-Time Interface” (“Real-Time Interface”, dSPACE Catalog 2012, pages 66 ff.).

The hardware elements located on the target hardware are controlled by the generated control program in accordance with the functionality modeled with the block-based modeling environment. Examples of possible hardware elements are digital and/or analog I/O interfaces, digital/analog converters, analog/digital converters, signal generators—such as, e.g., PWM signal generators, sine wave signal generators, and programmable arbitrary waveform generators —, multiplexers, demultiplexers, and also bus interfaces that implement a specific protocol (for example, CAN, FlexRay, Hart, 4-20 mA).

So that the functionalities of the hardware elements can be taken into account as early as within the block-based modeling environment, and thereby typically within a block diagram, the hardware elements or the functionalities of these hardware elements are made available in the block-based modeling environment in the form of a block. The hardware element itself is controlled on the target hardware by a hardware-specific item of code, which is typically referred to as a driver. The functionality implemented with the interaction of the hardware element and driver is referred to hereinafter as the driver function. Each driver function is made available in the block-based modeling environment in the form of a block representing the driver function.

For example, if an analog/digital converter of the target hardware is to be addressed as the hardware element, the block representing this driver function is used in the block-based modeling environment and is supplied with an appropriate signal. During translation of the model containing the driver function into an executable control program for the target hardware, the driver function—which is to say a program code item tailored to the specific target hardware—is incorporated into the control program so that the hardware element—here, the analog/digital converter—is addressed as desired on the target hardware when the control program is executed on the target hardware.

Suppliers of tools for supporting the above-described development process (block-based model generation, use of blocks representing driver functions to support hardware elements of a target hardware unit, code generation from the block-based model, and compilation of a control program executable on the target hardware) often provide the target hardware, the drivers for the hardware elements of the target hardware, and also the blocks representing the relevant driver functions for use in the block-based modeling environment. This means that the target hardware, the software support for the target hardware (drivers), and the support for a block-based modeling environment by blocks representing the driver function frequently come from a single source.

If hardware from a third-party supplier is to be incorporated into the tool chain, it is in any case necessary to create appropriate blocks for use in the block-based modeling environment that are tailored to the target hardware from the third-party supplier. It may also be necessary to create the drivers for supporting the target hardware from the third-party supplier, since they may not be present in a high-level programming language, and thus are not accessible to a code generation process that is necessary for creating a control program for the target hardware.

### SUMMARY OF THE INVENTION

It is therefore an object of the present invention to provide a method with which it is possible in a simple, automated manner to create a block for a block-based modeling environment that corresponds to a driver functionality, wherein this block represents the driver function of interest.

The object derived and stated above is attained in an embodiment by a computer-implemented method for automatic generation of at least one block representing a driver function for a block-based modeling environment in that a description of the driver function in a formal language is prepared, this formal-language description of the driver function is read in and evaluated, and the block representing the driver function is automatically generated for modeling of the driver function in a block diagram of the modeling environment.

Hence, the method according to an embodiment of the invention provides that a software implementation of the driver function is not present—for example in the form of C code and associated header files if applicable—but instead, a formal-language description of the driver function, which is to be distinguished therefrom, is specified. This formal-language description should be unambiguous; it can involve a proprietary formal language, but the use of a formal language having a standardized syntax, for example the Extensible Markup Language (XML) can be used here. This formal-language description includes all information required for generating a block representing the driver function.

The formal-language description of the driver function is then read in and evaluated as part of the computer-implemented method, wherein the computer-implemented reading and evaluation of the formal-language description takes place with the knowledge of the language elements of the formal-language description. In this way, it is possible to obtain information of interest, for example, a number of inputs and outputs of the driver function and thus of the block representing the driver function. The last part of the computer-implemented method, namely generating the block representing the driver function, is dependent on the block-based modeling environment used, because the generated block must be usable in the block-based modeling environment and hence must be oriented to the requirements of the description of a block in this block-based modeling environment.

The formal-language description of the driver function represents the interface between the supplier of the target hardware, and thus also the supplier of the driver for the target hardware or of the relevant hardware element of the target hardware, and the supplier of the tool chain with which an executable control program can ultimately be generated from a block-based modeling environment. Ideally, the supplier of the target hardware and driver also provides the formal-language description of the driver function, which can then be used by the supplier of the complete tool chain in order to incorporate the target hardware from the third-party supplier into the process of generating a control program from a block-based modeling environment. In this way it becomes possible in a very simple manner to generate blocks representing driver functions for third-party hardware that can then be used in a specific block-based modeling environment in order to be able to incorporate this target hardware, or the hardware elements of the target hardware, into the block-based modeling environment.

In an embodiment of the computer-implemented method, provision is made that the formal-language description of the driver function comprises at least one driver information item regarding the driver function for at least one of the following features: the function name (function_name) of the driver function, the block name (block_name) of the block representing the driver function, the name of a source code file (file) of the driver function, the name of a header file (header) of the driver function, the function type (function_type) of the driver function, the return type (returnvalue) of the driver function, the transfer parameters (parameter) of the driver function, the runtime mutability (runtime) of transfer parameters of the driver function, the call type (parameter type) of the transfer parameters of the driver function, the direction (direction) of a referenced parameter of the driver function, the data type (datatype) of a transfer parameter of the driver function, the lower limit (min) of the value range of a transfer parameter of the driver function, the upper limit (max) of the value range of a transfer parameter of the driver function, the initial value (init) of a transfer parameter of the driver function, the terminating value (term) of a transfer parameter of the driver function, the maximum sampling rate (task) of the driver function, the names of input and/or output values (input_name, output_name) of the driver function, the number of input and/or output values (input_number, output_number) of the driver function, the range of values of the input and/or output values (input_name_range, output_name_range) of the driver function, the physical scaling of input and/or output values (input_name_scale, output_name_scale) of the driver function, and/or the reference to protocols of input and/or output values ((input_name_protocol, output_name_protocol) of the driver function.

The driver function is uniquely identifiable by the function name, and the relationship to the block representing the driver function in the block-based modeling environment is produced by the block name. Specifying the source code file, and if applicable the name of an associated header file, makes it possible to access and implement the actual functionality of the hardware element of the target hardware by software, for example in a higher-level code generation process for creating a control program for the target hardware. Although this is not necessary for the automatic generation of a block for the driver function, it provides support in an ideal manner for the established development process as part of rapid control prototyping (RCP) or even as part of hardware-in-the-loop simulation (HIL).

The function type can be used to specify how the driver function is called in a control program, for example, whether it is only called as part of an initialization or termination of the program or else is called periodically during program execution, hence, for example, in each sampling interval of the real-time sampled-data system that is almost always implemented in practice via a control program.

The return type specifies the return type of the driver function, which is to say usually that of the C function on which the driver function is based. If no return value is present, the type “void” would be specified, for example. In other cases, the data types known for the process of the target hardware, as for example “uint16”, “int32” etc, can be specified.

Specifying the transfer parameters makes it clear that the driver function contains just such transfer parameters, wherein the transfer parameters should also be named if possible. If no transfer parameters are present, the specification can be omitted. For each transfer parameter of the driver function a corresponding element (“parameter”) is created as part of the formal-language description of the driver function. The specification of the transfer parameters can, if applicable, have effects on the creation of inputs and outputs on the generated block that represents the driver function.

The run-time mutability of transfer parameters specifies whether a transfer parameter is initially defined and cannot change during the run time of the control program that is ultimately created, or whether the transfer parameter can be influenced during program execution. One example of a transfer parameter that cannot be changed at run time could be the selection of the I/O pin through which a pulse-width-modulated signal (PWM signal) is output. In contrast, the pulse width of the PWM signal can also be variable at run time.

The call type of the transfer parameter of the driver function specifies whether the applicable transfer parameter uses a call-by-value call or a call-by-reference call. In this way, the block-based modeling environment can be informed as to whether the transfer parameter is itself a parameter value or if it is a pointer to a memory address that contains this parameter value. This information can be important in order to be able to represent the correct function call in the resulting program code for the control program.

Specification of the direction of a referenced parameter of the driver function specifies whether a call-by-reference parameter is used to transfer a value to a function—via a reference to a memory location—or whether the transfer parameter is used to change the value of a memory location in order to implement more than one return value for a function or else to save memory, for example. A combination of reading and writing a value is also possible. In this case, the value of a memory address is read into the function, evaluated, and then updated. The updated value can then be accessed in the control program. The direction of the data type can thus be specified using “in”, “out” or “in/out”, for example. In the first case the value of the memory address is used for reading within the function, in the second case an updated value is written to the passed memory address, and in the last case the value of a memory address is read, evaluated, and then updated within the function.

The data type of a transfer parameter of the driver function simply indicates the data type of the relevant transfer parameter, where this must be a data type that is known on the relevant target hardware.

The lower limit and the upper limit of the value range of a transfer parameter define the range in which the values for the relevant transfer parameter can run.

The initial value of a transfer parameter of the driver function serves to define the value of the transfer parameter at the start of program execution. Within the control program that is ultimately created, the transfer parameter is supplied with this value as part of real-time initialization. The same applies analogously to the terminating value of a transfer parameter, except that the transfer parameter is assigned this value in order to leave the target hardware in a defined final state after termination of the control program.

Specification of the maximum—if applicable also the optimum—sampling rate of the driver function gives an indication of the maximum sampling rate at which the relevant driver function should be used. Limit values of this type generally result from the limit values of the target hardware or the limit values of the particular hardware element affected on the target hardware. The minimum conversion time of an analog converter can serve as an example.

Names of input and/or output values of the driver function can also be given so that they can be specified by name. Specifying the number of input and/or output values of the driver function permits direct inference of a reasonable number of input and/or output values of the block that is to be created; specifying the value ranges of the input and/or output values serves to limit the input and/or output values to a permissible range. The physical scaling of the input and/or output values serves to specify the physical units of the value that is read in and/or output, as for example an electrical voltage in mV or a mechanical pressure in Pa.

Specifying a protocol—what can be a communications protocol—of input and/or output values of the driver function makes it possible to define the protocol to be used in formatting a signal that is to be output, or that should be used to interpret a signal that is to be read in if applicable.

The driver information items in the formal-language description of the driver function can be evaluated automatically, wherein the evaluation of the formal-language description can again be used in the generation of the block representing the driver function.

According to an embodiment of the method, provision is made, for example, that the number of return values of the driver function can be ascertained in the evaluation of the formal-language description of the driver function, and in the event that return values are present, at least one output is created on the generated block during generation of the block representing the driver function, in particular a number of outputs corresponding to the ascertained number of return values is created on the generated block.

Following this principle, provision is made in an embodiment of the computer-implemented method that the number of input and/or output values of the driver function can be ascertained in the evaluation of the formal-language description of the driver function, and in the event that input and/or output values are present, at least one input and/or at least one output is created on the generated block during generation of the block representing the driver function, in particular a number of inputs and/or outputs corresponding to the ascertained number of input and/or output values is created on the generated block.

In an embodiment of the computer-implemented method, provision is made that the run-time mutability of transfer parameters of the driver function can be ascertained in the evaluation of the formal-language description of the driver function, and in the event that at least one run-time-mutable transfer parameter is present, at least one input is created on the generated block during generation of the block representing the driver function, in particular a number of inputs corresponding to the ascertained number of run-time-mutable transfer parameters is created on the generated block.

In an embodiment of the computer-implemented method, provision is made in addition to the aforementioned measure that the run-time mutability of transfer parameters of the driver function can be ascertained in the evaluation of the formal-language description of the driver function, and in the event that at least one run-time-immutable transfer parameter is present, during generation of the block representing the driver function, at least one input option is created on the generated block to define the run-time-immutable transfer parameter at the time of the modeling, in particular a number of input options corresponding to the ascertained number of run-time-immutable transfer parameters is created on the generated block, in particular wherein the input option is implemented as a block screen. Thus, an option is created here to be able to define run-time-immutable transfer parameters. Since these do not have to be provided at run time, it is also not necessary to create an option for influencing them as part of the signal flow of the block-based model; instead, an input option independent of the functionality of the block diagram, as for example a block screen, is sufficient. This is to be understood as an input dialog that, for example, appears upon a “double-click” of the generated block, and thus allows input of the run-time-immutable transfer parameter or the value for this transfer parameter.

In an embodiment of the computer-implemented method, provision is made that the reading in and evaluation of the formal-language description of the driver function can be accomplished via the modeling environment, in particular in that it is implemented in a scripting language of the modeling environment. This has the advantage that there is no need to use yet another software tool for implementing the functionality of reading in and evaluation. The modeling environment may possibly also even provide functionalities that permit especially simple generation of the block representing the driver function. This avoids the need to implement functionalities anew elsewhere that are already provided in the modeling environment. In this regard, provision can be made that the generation of the block representing the driver function for modeling of the driver function in a block diagram of the modeling environment is accomplished via the modeling environment, in particular in that it is implemented in a scripting language of the modeling environment.

The object derived above is additionally attained by a formal description language for describing a driver function, wherein the driver function serves to control a hardware element of a target hardware unit, wherein the modeling of the driver function in a block diagram of a modeling environment is made possible through the provision of a formal-language description of the driver function in the formal description language, through the reading in and evaluation of the formal-language description of the driver function in the formal description language, and through generation of a block representing the driver function, wherein the formal description language includes at least one language element for identifying at least one driver information item of the driver function.

The formal description language takes on central importance in the above-described computer-implemented method because the formal description language is for intelligible description of the driver function that is completely divorced from the specific hardware and the specific software. It thus represents a universal interface between the manufacturer of the hardware and drivers, on the one hand, and the supplier of a tool chain that implements the work with block-based modeling environments and automatic code generation from the models of the block-based modeling environment on the other hand. In turn, the formal description language that the language element concerns at least one of the following features of the driver function: the function name (function_name) of the driver function, the block name (block_name) of the block representing the driver function, the name of a source code file (file) of the driver function, the name of a header file (header) of the driver function, the function type (function_type) of the driver function, the return type (returnvalue) of the driver function, the transfer parameters (parameter) of the driver function, the run-time mutability (runtime) of transfer parameters of the driver function, the call type (parameter type) of the transfer parameters of the driver function, the direction (direction) of a referenced parameter of the driver function, the data type (datatype) of a transfer parameter of the driver function, the lower limit (min) of the value range of a transfer parameter of the driver function, the upper limit (max) of the value range of a transfer parameter of the driver function, the initial value (init) of a transfer parameter of the driver function, the terminating value (term) of a transfer parameter of the driver function, the maximum sampling rate (task) of the driver function, the names of input and/or output values (input_name, output_name) of the driver function, the number of input and/or output values (input_number, output_number) of the driver function, the value range of the input and/or output values (input_name_range, output_name_range) of the driver function, the physical scaling of input and/or output values (input_name_scale, output_name_scale) of the driver function, and/or the reference to protocols of input and/or output values (input_name_protocol, output_name_protocol) of the driver function.

Further scope of applicability of the present invention will become apparent from the detailed description given hereinafter. However, it should be understood that the detailed description and specific examples, while indicating exemplary embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a method known from the prior art for producing an executable control program from a block diagram with a block representing a driver functionality for a target hardware unit;

FIG. 2 shows a schematic representation of the method according to an exemplary embodiment of the invention for automatic generation of a block representing a driver function;

FIG. 3 shows the method from FIG. 2, incorporating a source code file and a header file of a driver function;

FIG. 4 schematically shows the method according to an exemplary embodiment of the invention for automatic generation of a block by readout of a formal-language description of the driver function and evaluation of the specification contained in the description regarding the number of input and output values; and

FIG. 5 schematically shows the method according to an exemplary embodiment of the invention for automatic generation of a block with evaluation of the runtime mutability of transfer parameters.

### DETAILED DESCRIPTION

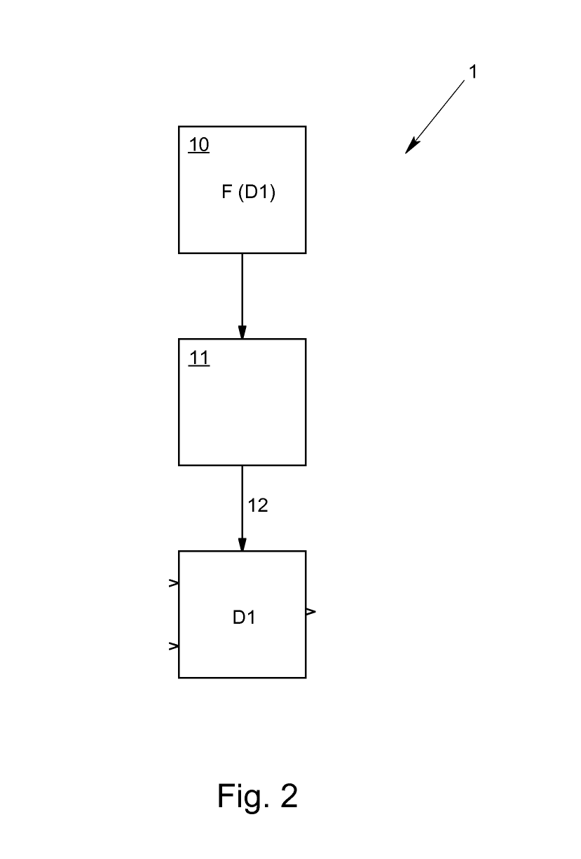

Shown in FIGS. 2 to 5 is a computer-implemented method 1 for automatic generation of at least one block D1′ representing a driver function D1 for a block-based modeling environment 2. The driver function D1 serves to control a hardware element 3 of a target hardware unit 4.

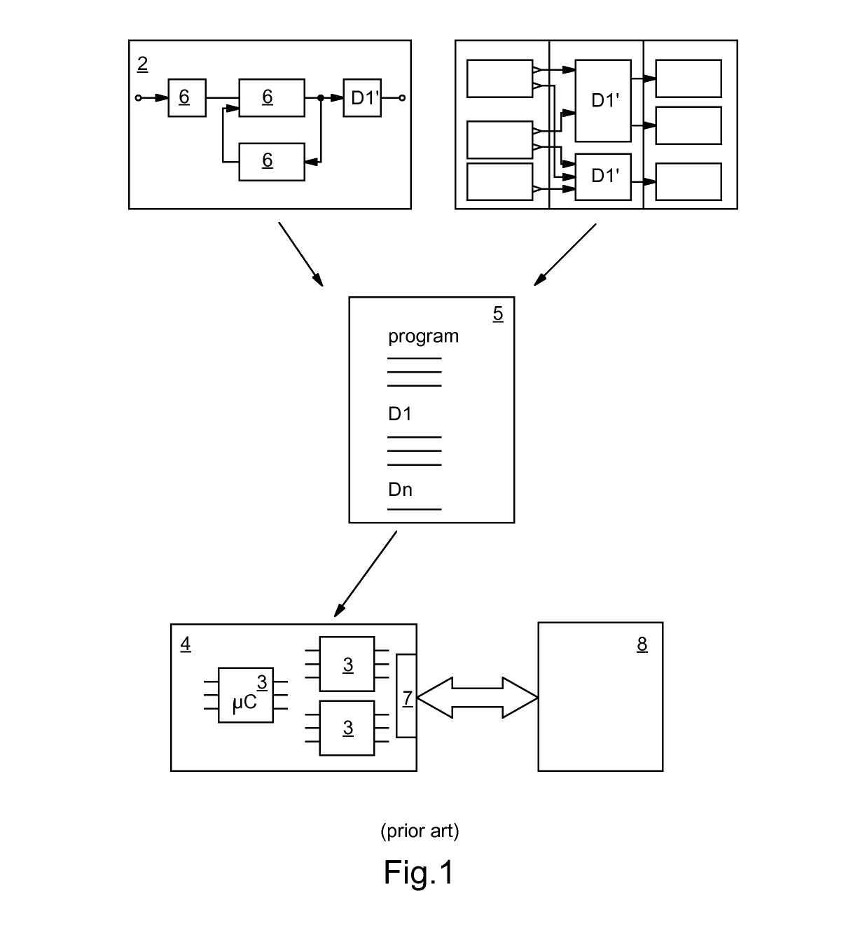

Shown in FIG. 1 is a computer-implemented method as is known from the prior art, wherein the depicted method shows in a larger context how blocks D1′ representing a driver function D1 are used within the framework of a modeling environment 2 to ultimately produce, in an automated manner, an executable control program 5 for the target hardware. Shown at the very top in FIG. 1 are two different variants of a block-based modeling environment 2. The left-hand top modeling environment 2 corresponds to work with a classic block diagram, where blocks 6, which do not include any hardware-related functionality, or in other words which represent only a mathematical transfer function, for instance, are mixed with blocks D1′, which have a driver function D1 with reference to a hardware element 3 of a target hardware unit 4. This type of hardware support for block diagrams is known in the prior art, for example from the applicant's Real-Time Interface.

Shown at the top right in FIG. 1 is a modeling environment 2, in which a subdivision is made between the outputs defined in a block diagram, the functionalities of the target hardware 4 or of the hardware elements 3 of the target hardware 4, and the outputs (pins) of the target hardware; this is indicated by the vertical columns that divide the model. Hardware support of this nature for a block-based modeling environment 2 is known from the prior art from the applicant's “ConfigurationDesk” tool.

The background for incorporating blocks D1′ representing a driver function D1 resides in the ability to generate, as automatically as possible, a control program 5 from the applicable block diagram or block-based modeling environment 2 that also comprises driver functionalities D1, Dn in addition to the signal-processing functionality of the non-hardware-related blocks 6, and that is translated for the target hardware 4 by a suitable compiler and is executable on the target hardware 4. The driver functions D1, Dn integrated in the control program 5 provide for appropriate control of the hardware elements 3 on the target hardware 4.

The target hardware 4 typically is a control unit with I/O interfaces 7. The control unit, which generally is a small computer with a real-time operating system, interacts through its I/O interfaces 7 with an external technical/physical process 8 that is to be influenced and/or observed, for example with an internal combustion engine, in that actuators are controlled and sensors are read.

The creation of a block D1′ representing a driver function D1 for hardware elements 3 of a target hardware unit 4 is comparatively labor-intensive, since the creation of such blocks D1′ requires not only knowledge of how blocks are to be provided in a suitable manner for the modeling environment 2 in the first place, but also knowledge of the hardware functionality and the specifics of the target hardware 4.

The computer-implemented method 1 for automatic generation of a block D1′ representing a driver function D1 shown in FIGS. 2 to 5 simplifies this process very greatly. The computer-implemented method 1 provides that a formal-language description F(D1) of the driver function D1 is first prepared 10. This is followed by the reading in and evaluation 11 of the formal-language description F(D1) of the driver function D1. On the basis of the knowledge of the driver function D1 thus obtained, the block D1′ representing the driver function D1 is generated 12, which serves the purpose of modeling of the driver function D1 in a block diagram of the modeling environment 2. No distinction is made in FIG. 1 between the modeling environment 2 and the block diagram of the modeling environment 1: the two coincide in the graphical representation.

The formal-language description F(D1) of the driver function D1 must be unambiguous, for which reason essentially any unambiguous description language can be used.

Provision is made that the formal-language description F(D1) of the driver function D1 comprises driver information regarding various features of the driver function D1, specifically regarding the function name (function_name) of the driver function, the block name (block_name) of the block representing the driver function, the name of a source code file (file) of the driver function, the name of a header file (header) of the driver function, the function type (function_type) of the driver function, the return type (returnvalue) of the driver function, the transfer parameters (parameter) of the driver function, the runtime mutability (runtime) of transfer parameters of the driver function, the call type (parameter type) of the transfer parameters of the driver function, the direction (direction) of a referenced parameter of the driver function, the data type (datatype) of a transfer parameter of the driver function, the lower limit (min) of the value range of a transfer parameter of the driver function, the upper limit (max) of the value range of a transfer parameter of the driver function, the initial value (init) of a transfer parameter of the driver function, the terminating value (term) of a transfer parameter of the driver function, the maximum sampling rate (task) of the driver function, the names of input and/or output values (input_name, output_name) of the driver function, the number of input and/or output values (input_number, output_number) of the driver function, the range of values of the input and/or output values (input_name_range, output_name_range) of the driver function, the physical scaling of input and/or output values (input_name_scale, output_name_scale) of the driver function, the reference to protocols of input and/or output values (input_name_protocol, output_name_protocol) of the driver function.

In the present case, the formal-language description F(D1) of the driver function D1 is written in Extensible Markup Language (XML). Shown below by way of example is a formal-language description F(D1) of a driver function D1 that is implemented as an XML data structure:

<function_name Name = “D1”>
<block_name>digital_outport</block_name>
<file>D1.c</file>
<header>D1.h</header>
<function_type>step</function_type>
<returnvalue>void</returnvalue>
<parameter Name = “par1”>
<runtime>)yes</runtime>
<parameter_type>call_by_value</parameter_type>
<direction>in</direction>
<datatype>Uint8</datatype>
<min>0</min>
<max>32</max>
<init>0</init>
<term>0</term>
</parameter>
<task>100ms</task>
<input_name>in_1</input_name>
<output_name>out_1</output_name>
<input_number>1</input_number>
<output_number>1</output_number>
<input_name_range>100</input_name_range>
<output_name_range>400</output_name_range>
<input_name_scale>mV</input_name_scale>
<output_name_scale>mA</output_name_scale>
</function_name>

The meaning of the various features of the driver function D1 has already been explained in the general section of the description.

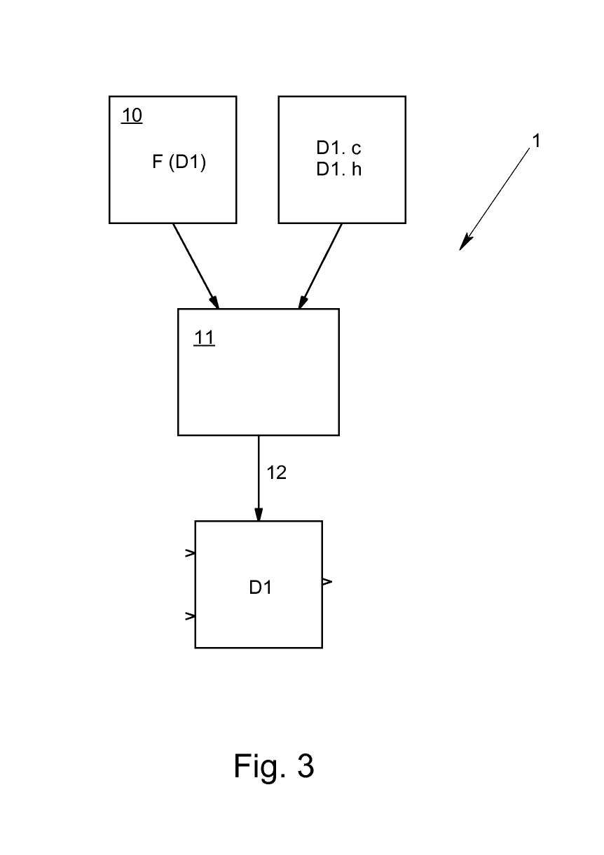

FIG. 3 illustrates that further information can be provided in addition to the formal-language description F(D1), namely in the form of a software implementation of the driver function D1, in the present case in the form of C code, here the file “D1.c” and the associated header file “D1.h”. Although this information is not required for the generation 12 of the block D1′ representing the driver function D1, this software implementation can be used in the later code generation process to produce the control program 5.

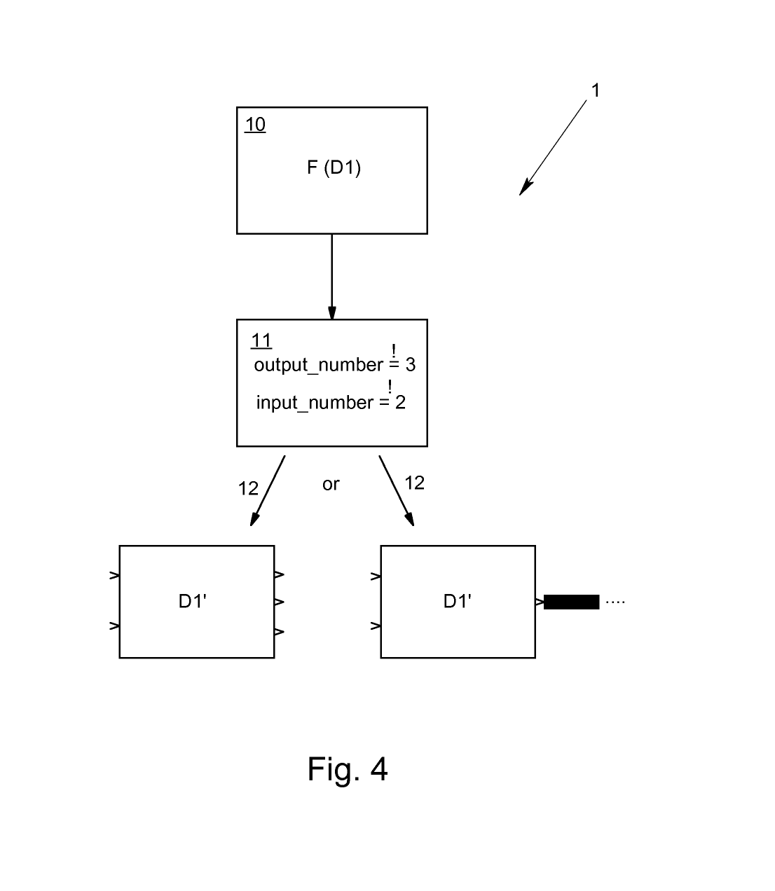

FIG. 4 shows by way of example how certain driver information items in the formal-language description F(D1) of the driver function D1 are used to generate the block D1′ representing the driver function D1. In the example shown, the data concerning the number of input and output values are evaluated, specifically the data concerning the parameters input_number and output_number. The value 3 is ascertained for the number of output values, and the value 2 for the number of input values. In the subsequent generation process 12 that leads to the bottom left-hand block D1′, corresponding numbers of block inputs and block outputs are created. In the generation process 12 that leads to the block D1′ shown at the bottom right, only a single block output is created, but three different output values can be transferred through the block output since they are superimposed on one channel using the multiplex principle.

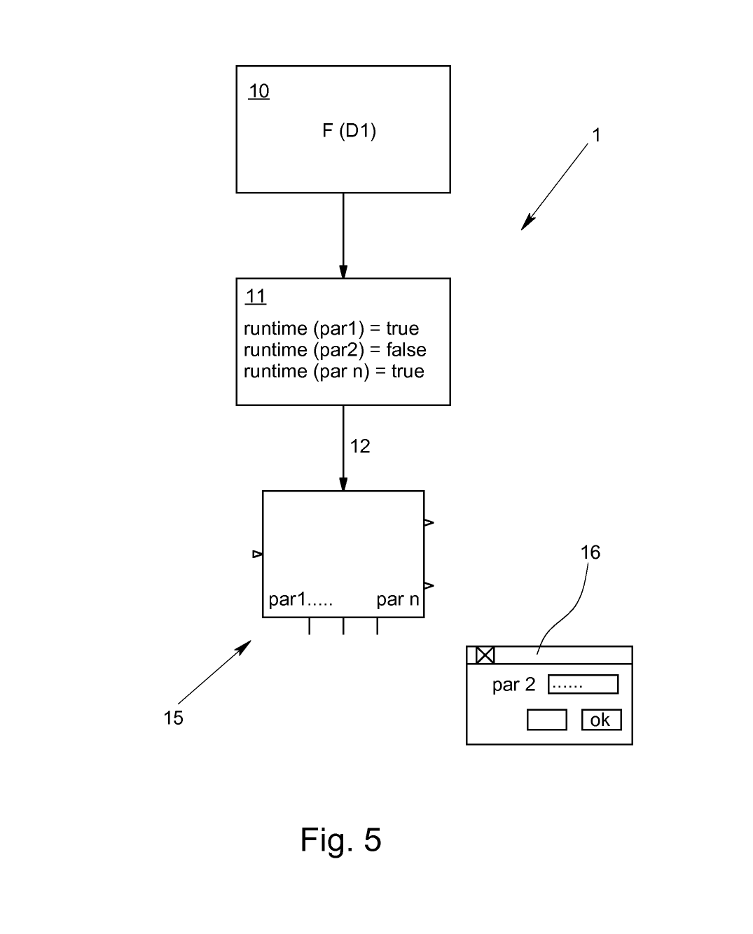

FIG. 5 shows another way of evaluating a driver information item, namely the information concerning the run-time mutability of transfer parameters. During the course of evaluation 11 of the formal-language description F(D1) of the driver function D1 that has been read in, the run-time mutability of various transfer parameters par1, par2, parn is examined. Because two of the parameters, namely the parameters par1 and parn, are run-time mutable, when the block D1′ representing the driver function D1 is generated 12, one input is created at the generated block D1′. These inputs are shown at the bottom edge on the generated block D1′ and are labeled with the parameter values par1, . . . , parn.

It is also evident from FIG. 5 that the run-time mutability of transfer parameters part par2, parn is ascertained during the evaluation 11 of the formal-language description F(D1) of the driver function D1, and in the instant case the presence of a run-time-immutable transfer parameter is detected, namely par2. During generation 12 of the block D1′ representing the driver function D1, an input option in the form of a dialog window 16 with reference to the generated block D1′ is then created. This input option 16 provides an opportunity for defining the run-time-immutable transfer parameter par2 that can be used at the time of the modeling. To this end, the dialog field 16 contains an input field in which it is possible to enter an appropriate value for the parameter par2. In the parlance of prior art block-based modeling environments, this is a block screen.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for automatic generation of at least one block representing a driver function for a block-based modeling environment, the method comprising:
preparing a description of the driver function in a formal language;
reading in and evaluating the formal-language description of the driver function; and
generating the block representing the driver function for modeling of the driver function in a block diagram of the modeling environment, wherein the driver function controls a hardware element of a target hardware unit.

2. The computer-implemented method according to claim 1, wherein the formal-language description of the driver function comprises at least one driver information item regarding the driver function for:
a function name of the driver function;
a block name of the block representing the driver function;
a name of a source code file of the driver function;
a name of a header file of the driver function;
a function type of the driver function;
a return type of the driver function;
transfer parameters of the driver function;
a runtime mutability of transfer parameters of the driver function;
a call type of the transfer parameters of the driver function;
a direction of a referenced parameter of the driver function;
a data type of a transfer parameter of the driver function;
a lower limit of the value range of a transfer parameter of the driver function;
an upper limit of the value range of a transfer parameter of the driver function;
an initial value of a transfer parameter of the driver function;
a terminating value of a transfer parameter of the driver function;
a maximum sampling rate of the driver function;
names of input and/or output values of the driver function;
a number of input and/or output values of the driver function;
range of values of the input and/or output values of the driver function;
a physical scaling of input and/or output values of the driver function; and/or
reference to protocols of input and/or output values of the driver function.

3. The computer-implemented method according to claim 2, wherein the number of return values of the driver function is ascertained in the evaluation of the formal-language description of the driver function, and wherein, in the event that return values are present, at least one output is created on the generated block during generation of the block representing the driver function or a number of outputs corresponding to the ascertained number of return values is created on the generated block.

4. The computer-implemented method according to claim 2, wherein the number of the input and/or output values of the driver function is ascertained in the evaluation of the formal-language description of the driver function, and wherein, in the event that input and/or output values are present, at least one input and/or at least one output is created on the generated block during generation of the block representing the driver function or a number of inputs and/or outputs corresponding to the ascertained number of input and/or output values is created on the generated block.

5. The computer-implemented method according to claim 2, wherein the run-time mutability of transfer parameters of the driver function is ascertained in the evaluation of the formal-language description of the driver function, and wherein, in the event that at least one run-time-mutable transfer parameter is present, at least one input is created on the generated block during generation of the block representing the driver function or a number of inputs corresponding to the ascertained number of run-time-mutable transfer parameters is created on the generated block.

6. The computer-implemented method according to claim 2, wherein the run-time mutability of transfer parameters of the driver function is ascertained in the evaluation of the formal-language description of the driver function, wherein, in the event that at least one run-time-immutable transfer parameter is present, during generation of the block representing the driver function, at least one input option is created on the generated block to define the run-time-immutable transfer parameter at the time of the modeling or a number of input options corresponding to the ascertained number of run-time-immutable transfer parameters is created on the generated block, and wherein the input option is implemented as a block screen.

7. The computer-implemented method according to claim 1, wherein the formal-language description of the driver function takes place in the Extensible Markup Language.

8. The computer-implemented method according to claim 1, wherein the reading in and evaluation of the formal-language description of the driver function is accomplished via the modeling environment or via a scripting language of the modeling environment.

9. The computer-implemented method according to claim 1, wherein generation of the block representing the driver function for modeling of the driver function in a block diagram of the modeling environment is accomplished via the modeling environment or via a scripting language of the modeling environment.

10. A formal description language for describing a driver function, the driver function controls a hardware element of a target hardware unit, the modeling of the driver function in a block diagram of a modeling environment is performed through the provision of the formal-language description of the driver function in the formal description language through a reading in and evaluation of the formal-language description of the driver function in the formal description language, and through generation of a block representing the driver function, wherein the formal description language includes at least one language element for identifying at least one driver information item of the driver function.

11. The formal description language for describing the driver function according to claim 10, wherein the language element of the driver function relates to:
a function name of the driver function;
a block name of the block representing the driver function;
a name of a source code file of the driver function;
a name of a header file of the driver function;
a function type of the driver function;
a return type of the driver function;
a transfer parameter of the driver function;
a run-time mutability of transfer parameters of the driver function;
a call type of the transfer parameters of the driver function;
a direction of a referenced parameter of the driver function;
a data type of a transfer parameter of the driver function;
a lower limit of the value range of a transfer parameter of the driver function;
an upper limit of the value range of a transfer parameter of the driver function;
an initial value of a transfer parameter of the driver function;
a terminating value of a transfer parameter of the driver function;
a maximum sampling rate of the driver function;
names of input and/or output values of the driver function;
a number of input and/or output values of the driver function;
a value range of the input and/or output values of the driver function;
a physical scaling of input and/or output values of the driver function; and/or
a reference to protocols of input and/or output values of the driver function.
